(19) United States
(12) Patent Application Publication
(10) Pub. No.: US 2022/0116873 A1
(43) Pub. Date: Apr. 14, 2022

(54) POWER SAVING MEDIA STREAMING IN A MOBILE DEVICE WITH CELLULAR LINK CONDITION AWARENESS

(71) Applicant: Intel Corporation, Santa Clara, CA (US)

(72) Inventors: Krishna Paul, Bangalore (IN); Sheetal Bhasin, Bangalore (IN); Venkatramanan Jayatheerthan, Bangalore (IN); Sandip Chakraborty, West Medinipur (IN); Basabdatta Palit, West Medinipur (IN); Niloy Ganguly, West Medinipur (IN)

(73) Assignee: Intel Corporation, Santa Clara, CA (US)

(21) Appl. No.: 17/645,812

(22) Filed: Dec. 23, 2021

(51) Int. Cl. H04W 52/02; H04L 65/61; H04N 21/437; H04N 21/44; H04N 21/414; H04N 21/466; H04N 21/442

(52) U.S. Cl. CPC H04W 52/0225; H04L 65/4069; H04N 21/437; H04N 21/44209; H04N 21/41407; H04N 21/4662; H04N 21/44004

(57) ABSTRACT

This disclosure describes systems, methods, and devices related to power saving media streaming. A device may determine a path trajectory. The device may utilize one or more inference models that predict one or more parameters associated with a media segment in a prefetch buffer on a wireless link. The device may send a request to a server, wherein the request indicates to the server to send the media segment using a predicted bit rate and a media segment prefetch size. The device may receive a playback buffer from the server at the predicted bit rate.

### TECHNICAL FIELD

This disclosure generally relates to systems and methods for wireless communications and, more particularly, to power saving media streaming in a mobile device with cellular link condition awareness.

### BACKGROUND

The evolution of communication systems poses increasing challenges from an energy consumption perspective. Computational tasks performed by mobile devices may increase as the complexity of such communication systems increases. One example of computational tasks may be the use of media content on a mobile device that may consume battery power. The media content may be downloaded from a content delivery network (CDN) to be viewed on the mobile device and therefore connections to a network may be required to access that media content. This would cause increased computational requirements. However, mobile device battery technology has not been able to evolve at the same pace as application complexity.

### BRIEF DESCRIPTION OF THE DRAWINGS

FIG. 1 illustrates example environment of a power saving media streaming system, in accordance with one or more example embodiments of the present disclosure.

FIG. 2 depicts an illustrative schematic diagram for a modem of a mobile device showing a connected state and an idle state.

FIG. 3 depicts an illustrative schematic diagram for example software components that may be present in a mobile device, in accordance with one or more example embodiments of the present disclosure.

FIG. 4 depicts an illustrative schematic diagram for power saving media streaming, in accordance with one or more example embodiments of the present disclosure.

FIG. 5 illustrates a flow diagram of a process for an illustrative power saving media streaming system, in accordance with one or more example embodiments of the present disclosure.

FIG. 6 illustrates a flow diagram of a process for an illustrative power saving media streaming system, in accordance with one or more example embodiments of the present disclosure.

FIG. 7 depicts an illustrative schematic diagram for machine learning for power saving media streaming, in accordance with one or more example embodiments of the present disclosure.

FIG. 8 is a block diagram illustrating an example of a computing device or computing system upon which any of one or more techniques (e.g., methods) may be performed, in accordance with one or more example embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

This disclosure proposes methods, systems, and apparatuses to increase battery life of a mobile device by reducing the modem connected state residency for mobile media streaming while current systems that prevalently uses dynamic adaptive streaming over hypertext transfer protocol-HTTP (DASH) algorithm (MPEG standard) for streaming quality of service (QoS).

In MPEG-DASH (referred to herein as DASH), a target video is broken into chunks (segments) of equal lengths (e.g., playback durations), which are stored at the CDN servers at different bitrates. The DASH client at the user handset, based on a few optimization parameters, downloads this chunk to the local playback buffer and subsequently renders them. This is done in order to reduce jitter of the network perceived by the user device. However, this method has an adverse impact on energy consumption of handheld as it does not take cellular link condition into account.

Example embodiments of the present disclosure relate to systems, methods, and devices for power saving video streaming in a mobile device with cellular link condition awareness.

In one embodiment, a power saving media streaming system may help mobile users to achieve better power saving during media streaming, while moving through adverse cellular link conditions. For a video streaming mobile, the power saving media streaming system for playback buffer control module of a video streaming client has the ability to factor in user cellular environment data by predicting upcoming mobile wireless link condition, and determine video segment download size, timing and bit rate in a manner so that mobile baseband RRC Connected state residency is minimized (comparing to existing methods), thus increasing the battery life of mobile during streaming.

In one or more embodiments, a power saving media streaming system may be decomposed into two primary elements:

1) A mechanism to collect trajectory data of the mobile data ad discover a pattern of signal quality. Most mobile users follow largely specific set of trajectories in day-to-day life. The proposed mechanism collects this data in the background to create user trajectory data set. A machine learning algorithm may be trained with data set to learn the trajectory/signal quality in relation to location data. The trained model can generate a prediction of signal quality, throughput, and optimal bitrate in upcoming time intervals <t1-t2> in mobile trajectory.

2) Client-side of stream media buffer prefetch algorithm is modified to include user location and signal quality, to decide the optimal buffer prefetch size/bitrate and download time to avoid unnecessary modem connected state residency.

In one or more embodiments, a power saving media streaming system may provide better battery life and utilize artificial intelligence (AI) accelerators in modern design that may provide a value add with low power inference with the benefit of battery savings.

If the video playback software knows that in a future time it will encounter a dead zone where signal strength is compromised, a power saving media streaming system may then prefetch a larger buffer in order to avoid trying that during the time where the dead zone will be encountered.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

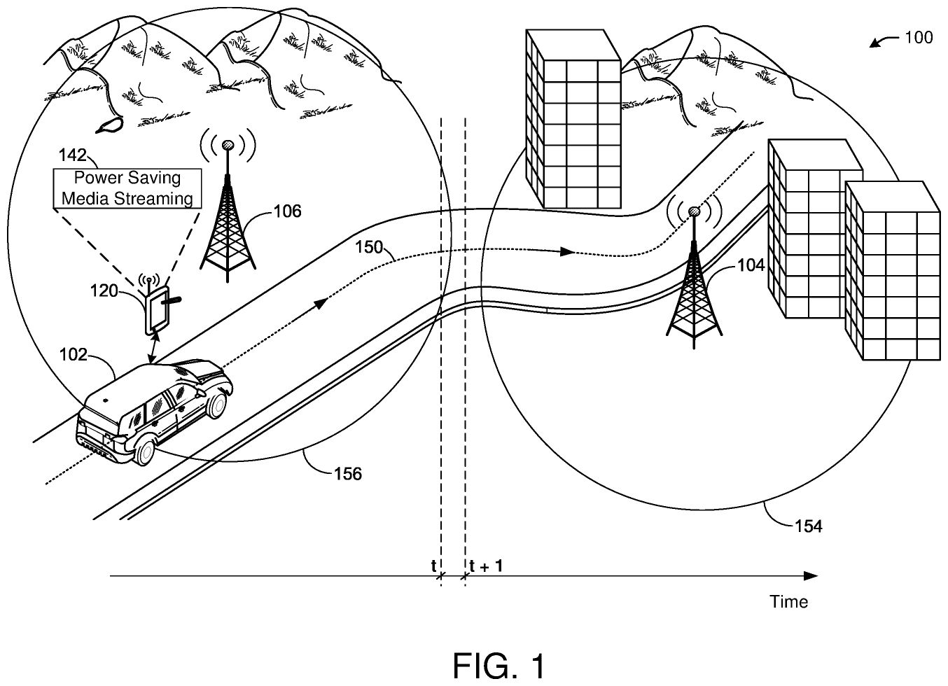

FIG. 1 illustrates example environment of a power saving media streaming system, in accordance with one or more example embodiments of the present disclosure.

Referring to FIG. 1, there is shown a vehicle 102 traversing a trajectory path 150. The vehicle 102 may contain a user device 120 that may communicate through a cellular and/or a Wi-Fi networks, or other wireless networks. As the vehicle 102 travels on the trajectory path 150, the user device 120 may be serviced by tours 104 and 106 in a cellular network.

In a cellular network, the way macrocells and microcells are designed, there may be a permanent one or more dead zones, where the signal does not reach the end-user or the signal is very weak. In addition, each user may have their own travel paths as they navigate throughout their environment. For example, as vehicle 102 traverses trajectory path 150 with the user device 120, it may encounter a number of patches where signal strength is low or non-existent (e.g., between coverage zones 156 and 154). When this happens, the way the modem operates on the user device 120, if there is a control packet going from a media playback buffer to the modem, the modem remains in a powered-up state. Since the user device 120 is in a dead zone, the modem continues to try to fetch data as a result the modem stays in a high power state. This results in wasteful battery power of the user device 120.

In one or more embodiments, a power saving media streaming 142 associated with the mobile device may achieve the ability to predict link throughput, optimal bitrate, video segment download size for media streaming client running in a mobile device, as the device moves along a trajectory through various environments. For example, while vehicle 102 reaches time t, it can predict link throughput, optimal bitrate, video segment download size for time t+1. This way, the modem of the user device 120 can transition to an idle state between times t and t+1 instead of being in a connected state.

It is understood that the above descriptions are for purposes of illustration and are not meant to be limiting.

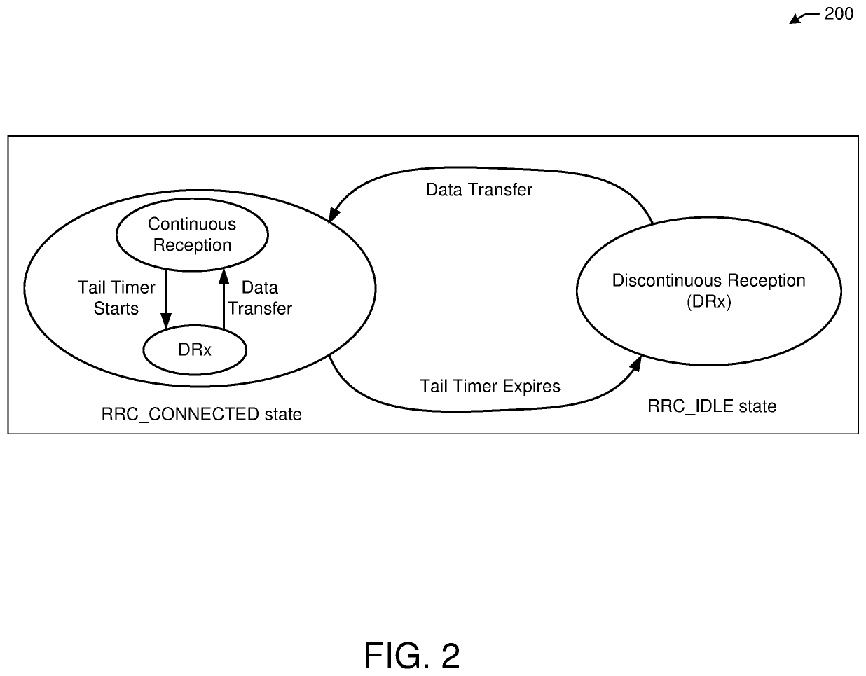

FIG. 2 depicts an illustrative schematic diagram for a modem of a mobile device showing a connected state and an idle state.

Referring to FIG. 2, there is shown a modem of a mobile device. The modem may be in either a connected state or an idle state. In the connected state, the mobile device may be available for continuous reception of data. In the idle state, the mobile device may be in a discontinuous reception of data (DRx). DRx is a method used in mobile communication to conserve the battery of the mobile device. The mobile device and the network negotiate phases in which data transfer occurs. During other times the device turns its receiver off and enters a low power state.

DASH is a video streaming approach for presenting the best possible quality of a specified video sequence to the end-user. DASH is an HTTP-based standard that offers a method of informing users about multiple transport streams (TS) with different quality levels and providing information on the best transmission path. DASH is extensively used using standards in the content distribution network (CDN) hosting videos, adaptive bitrate streaming (ABR) streaming over HTTP to deliver promised QoS to users. Multiple files of the same content, in different size files, are offered to a user's video player, and the client chooses the most suitable file to playback on the device.

MPEG-DASH uses ABR algorithms that optimize prefetch decision on buffer size, network throughput rate, user-defined QoS parameters, or a combination of these factors. These require an optimization problem to be solved to meet desired download rate. Some of these have reported using a machine learning (ML) based approach to arrive at solutions optimally.

ABR based client server protocol does not consider wireless channel quality and user trajectory prediction when making download bitrate decisions which result in sub-optimal download bitrate and increased energy consumption in the mobile device.

Excess power is spent by modem radiofrequency (RF), in a situation when a client is downloading a high bitrate segment under a rapidly fluctuating channel condition (e.g., during mobility), as the RF stays in radio resource control (RRC) Connected state (most power consuming state of RF in modem) for a longer time. It is understood that the above descriptions are for purposes of illustration and are not meant to be limiting.

Currently, there are no solutions that provide a battery optimized streaming experience when mobile is moving through various cellular conditions of strong or weak connection with a base station or through blind zones.

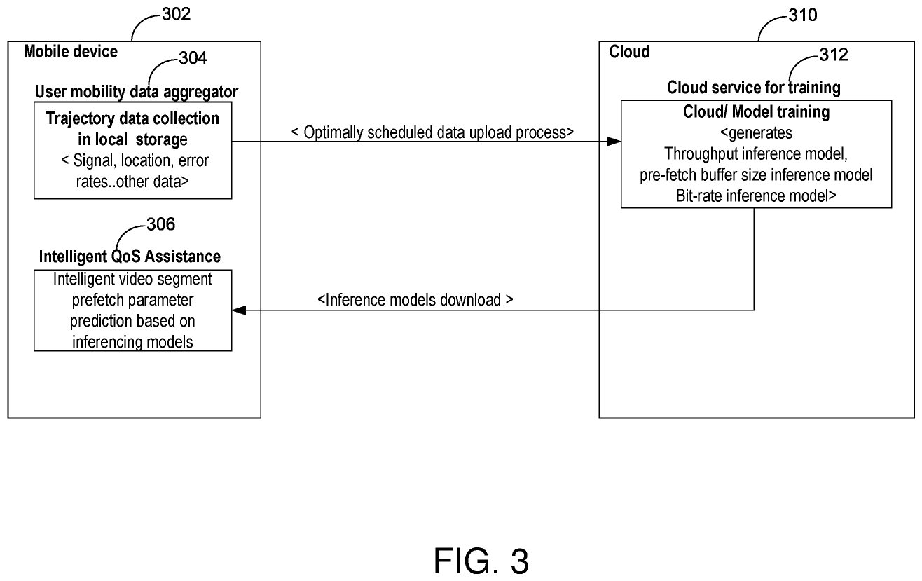

FIG. 3 depicts an illustrative schematic diagram for example software components that may be present in a mobile device 302, in accordance with one or more example embodiments of the present disclosure.

In one or more embodiments, a power saving media streaming system may facilitate the design of the power smart buffer prefetch schedule.

In one or more embodiments, a power saving media streaming system may perform learning of mobile trajectory patterns using data collection over a plurality of locations and environments. Based on that, a learning algorithm is trained with the collected data to predict network throughput in a trajectory. Then, based on that prediction, the power saving media streaming system may calculate the size of buffer size for prefetching data.

In one or more embodiments, a power saving media streaming system may achieve the ability to predict link throughput, optimal bitrate, video segment download size for media streaming client running on a mobile device, as the device moves along a trajectory through various environments.

The decision engine is based on deep learning (DL) trained model, the power saving media streaming system may facilitate a) a real-time method to collect training data, b) a mechanism to train the model in edge CDN, and c) the use of models in the decision engine.

After the initial data collection that has been uploaded to the cloud in an original training model, a mobile device may continue to collect data based on its trajectory. For example, a mobile device may be used to collect data by probing its modem interface. The data may be scheduled at various intervals to be uploaded to the cloud while traversing a trajectory. The cloud may comprise ML models that may be used and inference models may be generated and downloaded to the mobile device. Inference models may include a throughput inference model, a prefetch buffer size inference model, and a bit rate inference model. It is understood that cloud service is an infrastructure, platform, or software that is hosted by third-party providers and made available to users through the internet. Users can access cloud services with nothing more than a computer, operating system, and internet connectivity, or virtual private network (VPN).

In one or more embodiments, a power saving media streaming system may facilitate that a mobile device (e.g., mobile device 302) may run a streaming media client which may include a media player (e.g., a power-smart video player) to render the streaming media, along with a training data acquisition module to collect the runtime buffer states and cellular environment data which are used for training the ML model that helps in a prefetch schedule, prefetch buffer size, and bitrate decision. The video player forwards DASH Media Request (containing current playback information) to a video server over a transmission control protocol (TCP) connection.

In one or more embodiments, a power saving media streaming system the mobile device (e.g., mobile device 302) may include a user mobility data aggregator 304 and an intelligent QoS assistance 306.

The user mobility data aggregator 304 may be a module that helps in collecting mobile data along a trajectory that the user may be traversing. The mobile data may include baseband telemetry, such as signal strength, signal-to-noise ratio (SNR), number of handovers, technology, link rate, error rates, location, or any other data. The collected mobile data may be collected over time. The mobile device 302 may store the collected data in local storage, and uploads it to a backend server (e.g., cloud 310) based on a user-defined schedule (e.g., in bursts). This mechanism may reject redundant and repetitive data to reduce temporary storage requirements.

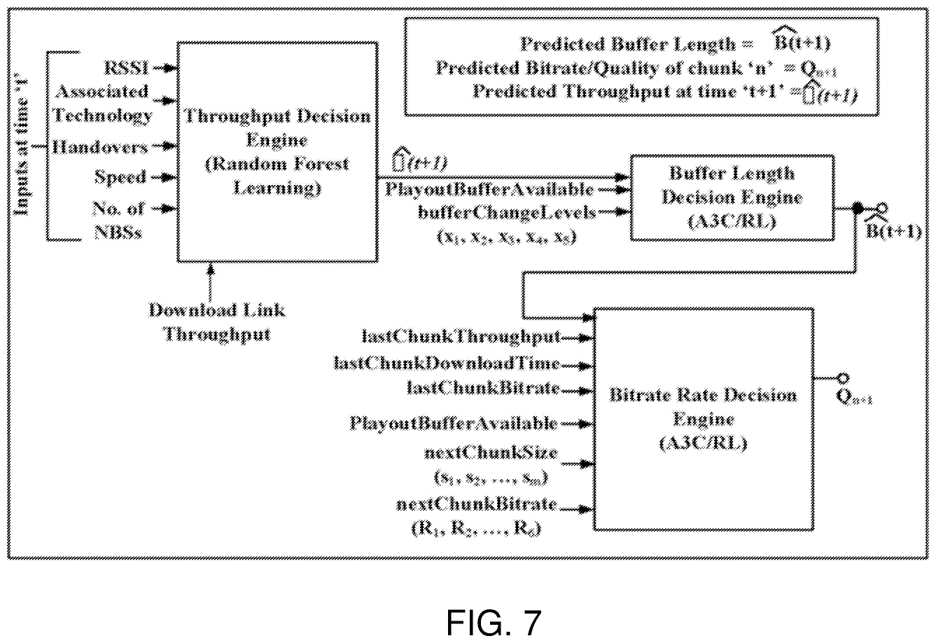

In one or more embodiments, a power saving media streaming system may facilitate utilizing a cloud service for training 312. The trajectory data may be uploaded to a cloud-hosted service which trains a model to be able to predict throughput, optimal bitrate, and optimal video segment download size for a mobile that is moving on a trajectory, such that, if there is a bad signal spot in trajectory, the model does not need to make failed attempt to download and remain in a connected state. The data contains (i) runtime buffer states, and (ii) cellular environment data. Three ML models are trained using these data—(a) the throughput inference model that predicts the wireless link throughput, (b) the buffer length inference model, which decides the amount of data to be prefetched and stored at the mobile device to save the energy wastage due to data fetching over a poor wireless channel, (c) the bitrate inference model, which decides the bitrate for the segment to be downloaded. These training models use the network and playback statistics data up to time t to determine these parameters for time t+1. These inference models may be generated as described in FIG. 7.

The intelligent QoS assistant 306 may be a runtime agent supporting the media streaming buffer control decision to determine the “video segment prefetch schedule (when) and corresponding bitrate” (what) in tune with upcoming wireless channel condition (how) to the mobile streaming client. Upon receiving a media request message from the streaming client, inferencing engines may be used to decide the playback bitrate and the buffer state for the corresponding video segments, updates the media requests message with the inferred bitrate information, and forward the message to the video server as per the exiting streaming client server protocol. This module receives the trained models from cloud for QoS prefetch parameter prediction and interfaces with the media streaming client ABR QoS module.

It is understood that the above descriptions are for purposes of illustration and are not meant to be limiting.

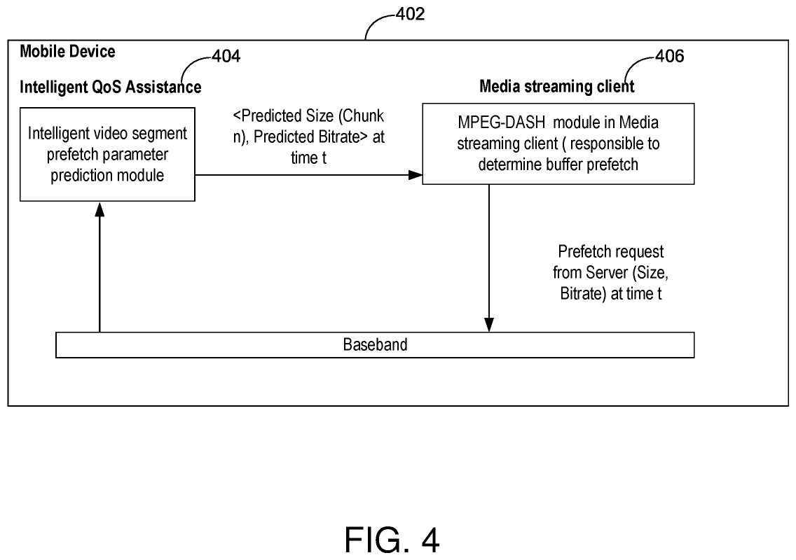

FIG. 4 depicts an illustrative schematic diagram for power saving media streaming, in accordance with one or more example embodiments of the present disclosure.

In one or more embodiments, a power saving media streaming system may facilitate a power smart prefetch schedule that enhances a user device's battery usage while processing media on the mobile device as the mobile device traverses a path.

Referring to FIG. 4 there is shown a mobile device 402 that may comprise an intelligent QoS assistant 404 communicating with the media streaming client 406 that may be responsible for determining buffer prefetch size associated with a media content to be used on the mobile device (e.g., a video, or any other type of media). The media streaming client 406 may comprise information associated with a user location and signal quality to decide the optimal buffer prefetch size/bitrate and download time to avoid unnecessary modem connected state while going through a zone that may have a low signal quality or no signal. In one example, the media streaming client 406 may utilize location and network quality prediction during mobile media streaming. The media streaming client 406 may also determine a look ahead media streaming prefetch buffer size and bit rate decision.

The data collected during training may be saved to a server. A machine learning mechanism may be used with the data to perform the prediction. One or more inference models may be downloaded to the mobile device in order to perform prediction based on the inference models to determine the prefetch buffer for video playback. Inference models may include a throughput inference model, a prefetch buffer size inference model, and a bit rate inference model.

It is understood that the above descriptions are for purposes of illustration and are not meant to be limiting.

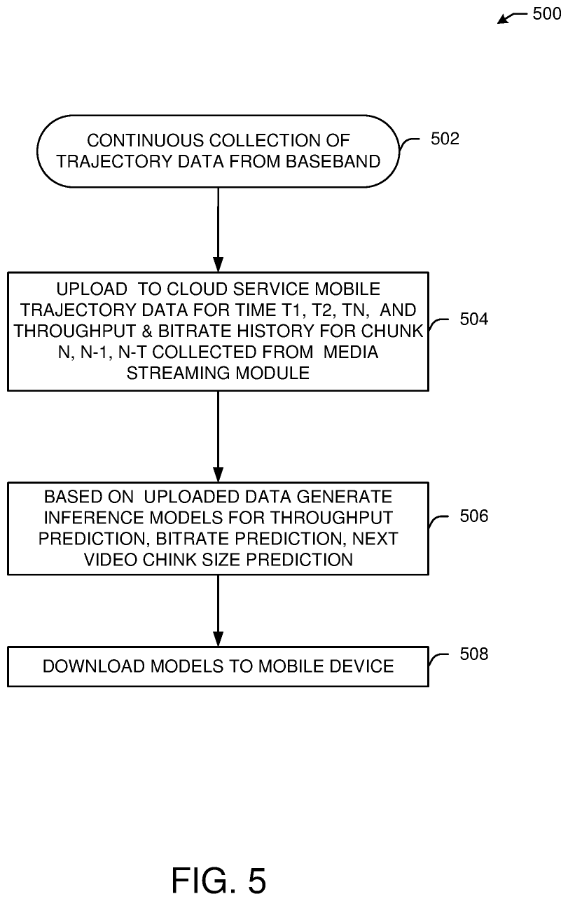

FIG. 5 illustrates a flow diagram of a process 500 for a power saving media streaming system, in accordance with one or more example embodiments of the present disclosure.

Referring to FIG. 5, there is shown a real-time data collection and model training process flow, where the Process flow is between a mobile device and a cloud service (e.g., a server) for mobile trajectory data collection and training models (throughput, bitrate, chunk size) in the cloud.

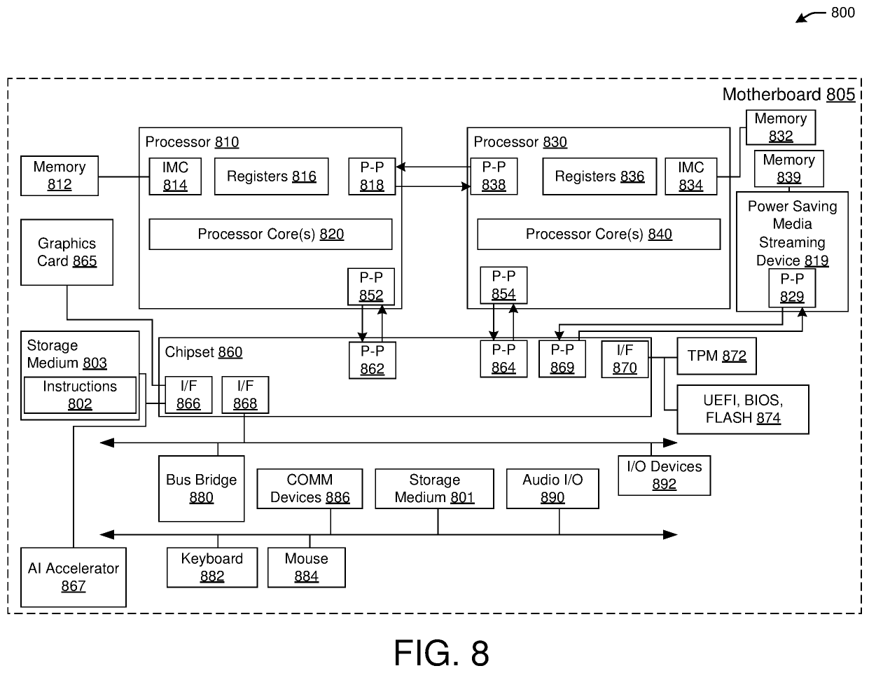

At block 502, a device (e.g., the power saving media streaming device of FIG. 1 and/or the power saving media streaming device 809 of FIG. 8) may perform continuous collection of trajectory data from the baseband of the device, where the data may be stored on a mobile device.

At block 504, the device may upload the collected trajectory data to a mobile service for various times (e.g., t1, t2, . . . , tn, where n is a positive integer). The device may also upload throughput and bitrate history for media segments (chunks n) n, n−1, . . . , n−t, which may be collected from a media streaming module, where t is a positive integer in a sequence. The upload may be done at an optimal time and size.

At block 506, the device may generate inference models for throughput prediction, betrayed prediction, next video chunk size prediction at any point in time for the device.

At block 508, the device may download the inference models from the cloud service to the mobile device.

It is understood that the above descriptions are for purposes of illustration and are not meant to be limiting.

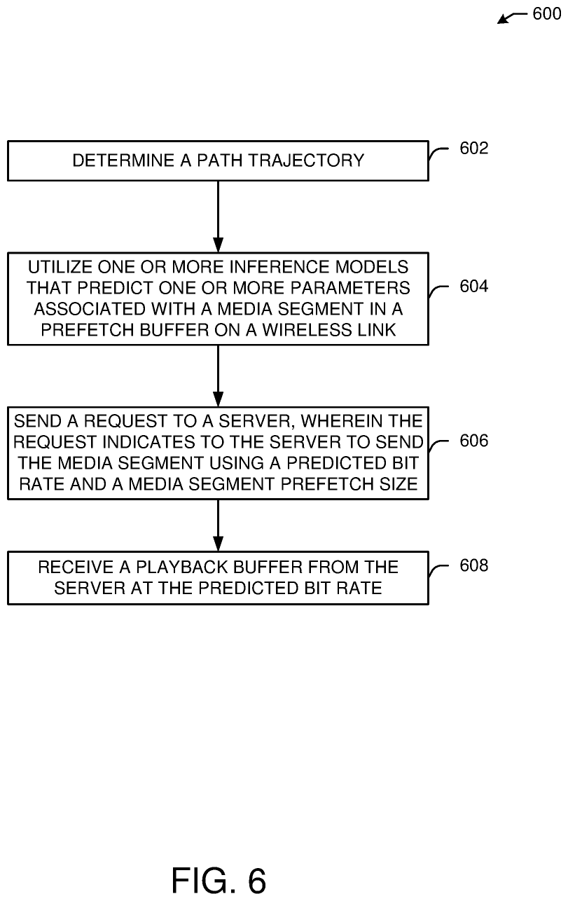

FIG. 6 illustrates a flow diagram of a process 600 for a power saving media streaming system, in accordance with one or more example embodiments of the present disclosure.

FIG. 6 shows an example process flow between a media streaming client QoS buffer prefetch module and a media server.

At block 602, a device (e.g., the power saving media streaming device of FIG. 1 and/or the power saving media streaming device 809 of FIG. 8) may determine a path trajectory. On the device, an intelligent QoS assistance module probes current trajectory location. This may occur while client media streaming started.

At block 604, the device may utilize one or more inference models that predict one or more parameters associated with a media segment in a prefetch buffer on a wireless link. Intelligent QoS Assistant may use inference models to predict Bitrate, and video chunk size fore prefetching

At block 606, the device may send a request to a server, wherein the request indicates to the server to send the media segment using a predicted bit rate and a media segment prefetch size. For example, the media streaming client QoS module may send the request to a server to send a next video chunk with prefetch size and bitrate.

At block 608, the device may receive a playback buffer from the server at the predicted bit rate. For example, the media streaming client may receive the playback buffer at requested bitrate.

It is understood that the above descriptions are for purposes of illustration and are not meant to be limiting.

FIG. 7 depicts an illustrative schematic diagram for machine learning for power saving media streaming, in accordance with one or more example embodiments of the present disclosure.

Referring to FIG. 7, there are shown details for DL model implementation. This shows additional information providing details of three DL models used in a power saving media streaming system. In the machine learning for power saving media streaming, three decision engines may be used to generate inference models that may include a throughput inference model, a prefetch buffer size inference model, and a bit rate inference model. The three engines may be a throughput decision engine, a buffer length decision engine, and a bitrate decision engine.

In the throughput decision engine, a random forest learning (RFL) model is used to train a regression model. Based on historical data (collected by Training Server, in past x time unit) at time (t), model predicts the average throughput (PxFT) that may be experienced by the user during the time slot (of length ‘T’). The input features of the throughput prediction engine are: (a) received signal strength indicator (RSSI), (b) technologies used—LTE (4G), HSPA+ (3.75G), UMTS (3G), EDGE (2G), (c) number of vertical and horizontal handovers, (d) speed of the mobile, (e) number and technology of neighboring Base Stations (BSs), (f) download link throughput—the download rate is measured at the UE in bytes per second.

The Buffer Length Decision Engine (BLD) predicts the playback buffer length from the predicted network throughput at the beginning of each time slot. However, the relationship between the two is non-trivial and analytically intractable. Therefore, Actor-Critic (A3C) reinforcement learning (RL)-based deep neural network is used to determine the optimal buffer length. The A3C RL algorithm has the following components—(a) input states to the algorithm at time instance t, (b) the action of the algorithm, which indicates whether to increase or decrease the buffer length at time instance t, (c) the reward function to determine the action from the input states. The input state to the buffer length decision engine at the beginning of time slot ‘t’ includes a) the predicted network throughput, b) the available playback buffer length, and c) the changes in the buffer level. The reward function of the RL algorithm is given by a linear weighted function of energy savings with respect to a baseline ABR algorithm and the QoE score:

$${Ξ}_{bufflen} = {w}_{1} \cdot \vert {E}_{EdgeDASH} - {E}_{Old} \vert + {w}_{2} \cdot QoE \qquad ( 1 )$$

The first term in the reward function gives the energy savings with respect to a baseline ABR algorithm. E_{EdgeDASH} and E_{Old} represent the energy consumption of EdgeDASH and the baseline algorithm. The energy consumed while using one particular algorithm is obtained as follows: the Radio Resource Control (RRC) states are first identified from the download packet capture of a video trace. Next, the dwell time in each RRC state is multiplied by the corresponding power consumption (obtained from the RRC state machine) to get the energy quantities. The QoE component in Equation (1) above is computed as follows.

$$QoE = {\sum }_{i = 1}^{N} q ( {R}_{i} ) - μ {\sum }_{i = 1}^{N} {δ}_{i} - {\sum }_{i = 1}^{N - 1} \vert q ( {R}_{i + 1} ) - q ( {R}_{i} ) \vert \qquad ( 2 )$$

The QoE metric is defined for a video with N segments and is computed based on the QoE parameters measured for each segment. Rᵢ is the bitrate of chunk i. q(Rᵢ) maps the bitrate to a quantity that represents the quality perceived by the user. q(Rᵢ)=Rᵢ is used. δᵢ is the rebuffering time during the downloading of segment i at bitrate Rᵢ. μ represents the degree of penalty associated with δᵢ. μ=4.3 is used. The last term in Equation (2) represents the playback smoothness.

In the Bitrate Decision Engine, the predicted playback buffer length is used just before downloading a video segment for selecting an optimal bitrate using a deep reinforcement learning based algorithm. The input state before downloading segment n includes: a) the predicted playback buffer length for the current time slot ‘t’, b) throughput of the last segment, c) time taken to download the last video segment, d) bitrate of the last segment, e) available playback buffer length, f) Possible size of the next video segment, g) possible bitrate levels of the next video segment. The reward function is the aforementioned QoE metric as shown in Equation (2). The output action of this RL algorithm is a bit rate from the available bitrates as configured in the MPEG-DASH.

It is understood that the above descriptions are for purposes of illustration and are not meant to be limiting.

FIG. 8 illustrates an embodiment of an exemplary system 800, in accordance with one or more example embodiments of the present disclosure.

In various embodiments, the computing system 800 may comprise or be implemented as part of an electronic device.

In some embodiments, the computing system 800 may be representative, for example, of a computer system that implements one or more elements of FIG. 1 (e.g., vehicle 102 or user device 120).

The embodiments are not limited in this context. More generally, the computing system 800 is configured to implement all logic, systems, processes, logic flows, methods, equations, apparatuses, and functionality described herein and with reference to FIGS. 1-7.

The system 800 may be a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, a handheld device such as a personal digital assistant (PDA), or other devices for processing, displaying, or transmitting information. Similar embodiments may comprise, e.g., entertainment devices such as a portable music player or a portable video player, a smart phone or other cellular phones, a telephone, a digital video camera, a digital still camera, an external storage device, or the like. Further embodiments implement larger scale server configurations. In other embodiments, the system 800 may have a single processor with one core or more than one processor. Note that the term “processor” refers to a processor with a single core or a processor package with multiple processor cores.

More generally, the computing system 800 is configured to implement all logic, systems, processes, logic flows, methods, apparatuses, and functionality described herein with reference to the above figures.

As used in this application, the terms “system” and “component” and “module” are intended to refer to a computer-related entity, either hardware, a combination of hardware and software, software, or software in execution, examples of which are provided by the exemplary system 800. For example, a component can be, but is not limited to being, a process running on a processor, a processor, a hard disk drive, multiple storage drives (of optical and/or magnetic storage medium), an object, an executable, a thread of execution, a program, and/or a computer.

By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in this figure, system 800 comprises a motherboard 805 for mounting platform components. The motherboard 805 is a point-to-point interconnect platform that includes a processor 810, a processor 830coupled via a point-to-point interconnects as an Ultra Path Interconnect (UPI), and a power saving media streaming device 819. In other embodiments, the system 800 may be of another bus architecture, such as a multi-drop bus. Furthermore, each of processors 810 and 830 may be processor packages with multiple processor cores. As an example, processors 810 and 830 are shown to include processor core(s) 820 and 840, respectively. While the system 800 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 810 and the chipset 860. Some platforms may include additional components and some platforms may only include sockets to mount the processors and/or the chipset.

The processors 810 and 830 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processors 810, and 830.

The processor 810 includes an integrated memory controller (IMC) 814 and point-to-point (P-P) interfaces 818 and 852. Similarly, the processor 830 includes an IMC 834 and P-P interfaces 838 and 854. The IMC's 814 and 834 couple the processors 810 and 830, respectively, to respective memories, a memory 812 and a memory 832. The memories 812 and 832 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 812 and 832 locally attach to the respective processors 810 and 830.

In addition to the processors 810 and 830, the system 800 may include a power saving media streaming device 819. The power saving media streaming device 819 may be connected to chipset 860 by means of P-P interfaces 829 and 869. The power saving media streaming device 819 may also be connected to a memory 839. In some embodiments, the power saving media streaming device 819 may be connected to at least one of the processors 810 and 830. In other embodiments, the memories 812, 832, and 839 may couple with the processor 810 and 830, and the power saving media streaming device 819 via a bus and shared memory hub.

System 800 includes chipset 860 coupled to processors 810 and 830. Furthermore, chipset 860 can be coupled to storage medium 803, for example, via an interface (I/F) 866. The I/F 866 may be, for example, a Peripheral Component Interconnect-enhanced (PCI-e). The processors 810, 830, and the power saving media streaming device 819 may access the storage medium 803 through chipset 860.

Storage medium 803 may comprise any non-transitory computer-readable storage medium or machine-readable storage medium, such as an optical, magnetic or semiconductor storage medium. In various embodiments, storage medium 803 may comprise an article of manufacture. In some embodiments, storage medium 803 may store computer-executable instructions, such as computer-executable instructions 802 to implement one or more of processes or operations described herein, (e.g., processes 500 and 600 of FIGS. 5 and 6). The storage medium 803 may store computer-executable instructions for any equations depicted above. The storage medium 803 may further store computer-executable instructions for models and/or networks described herein, such as a neural network or the like. Examples of a computer-readable storage medium or machine-readable storage medium may include any tangible media capable of storing electronic data, including volatile memory or non-volatile memory, removable or non-removable memory, erasable or non-erasable memory, writable or re-writable memory, and so forth. Examples of computer-executable instructions may include any suitable types of code, such as source code, compiled code, interpreted code, executable code, static code, dynamic code, object-oriented code, visual code, and the like. It should be understood that the embodiments are not limited in this context.

The processor 810 couples to a chipset 860 via P-P interfaces 852 and 862 and the processor 830 couples to a chipset 860 via P-P interfaces 854 and 864. Direct Media Interfaces (DMIs) may couple the P-P interfaces 852 and 862 and the P-P interfaces 854 and 864, respectively. The DMI may be a high-speed interconnect that facilitates, e.g., eight Giga Transfers per second (GT/s) such as DMI 3.0. In other embodiments, the processors 810 and 830 may interconnect via a bus.

The chipset 860 may comprise a controller hub such as a platform controller hub (PCH). The chipset 860 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 860 may comprise more than one controller hub such as a chipset with a memory controller hub, a graphics controller hub, and an input/output (I/O) controller hub.

In the present embodiment, the chipset 860 couples with a trusted platform module (TPM) 872 and the UEFI, BIOS, Flash component 874 via an interface (I/F) 870. The TPM 872 is a dedicated microcontroller designed to secure hardware by integrating cryptographic keys into devices. The UEFI, BIOS, Flash component 874 may provide pre-boot code.

Furthermore, chipset 860 includes the I/F 866 to couple chipset 860 with a high-performance graphics engine, graphics card 865. In other embodiments, the system 800 may include a flexible display interface (FDI) between the processors 810 and 830 and the chipset 860. The FDI interconnects a graphics processor core in a processor with the chipset 860.

Various I/O devices 892 couple to the bus 881, along with a bus bridge 880 which couples the bus 881 to a second bus 891 and an I/F 868 that connects the bus 881 with the chipset 860. In one embodiment, the second bus 891 may be a low pin count (LPC) bus. Various devices may couple to the second bus 891 including, for example, a keyboard 882, a mouse 884, communication devices 886, a storage medium 801, and an audio I/O 890.

The artificial intelligence (AI) accelerator 867 may be circuitry arranged to perform computations related to AI. The AI accelerator 867 may be connected to storage medium 803 and chipset 860. The AI accelerator 867 may deliver the processing power and energy efficiency needed to enable abundant-data computing. The AI accelerator 867 is a class of specialized hardware accelerators or computer systems designed to accelerate artificial intelligence and machine learning applications, including artificial neural networks and machine vision. The AI accelerator 867 may be applicable to algorithms for robotics, internet of things, other data-intensive and/or sensor-driven tasks.

Many of the I/O devices 892, communication devices 886, and the storage medium 801 may reside on the motherboard 805 while the keyboard 882 and the mouse 884 may be add-on peripherals. In other embodiments, some or all the I/O devices 892, communication devices 886, and the storage medium 801 are add-on peripherals and do not reside on the motherboard 805.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

In addition, in the foregoing Detailed Description, various features are grouped together in a single example to streamline the disclosure. This method of disclosure is not to be interpreted as reflecting an intention that the claimed examples require more features than are expressly recited in each claim. Rather, as the following claims reflect, the inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions that, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chipset, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language, and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The following examples pertain to further embodiments.

Example 1 may include a system that comprises at least one memory that stores computer-executable instructions; and at least one processor configured to access the at least one memory and execute the computer-executable instructions to: determine a path trajectory; utilize one or more inference models that predict one or more parameters associated with a media segment in a prefetch buffer on a wireless link; send a request to a server, wherein the request indicates to the server to send the media segment using a predicted bit rate and a media segment prefetch size; and receive a playback buffer from the server at the predicted bit rate.

Example 2 may include the system of example 1 and/or some other example herein, wherein the one or more inference models are downloaded from a cloud service to the device.

Example 3 may include the system of example 1 and/or some other example herein, wherein the one or more inference models are trained using data collected over time while traversing various environments.

Example 4 may include the system of example 1 and/or some other example herein, wherein a training of the one or more inference models comprises continuous collection of trajectory data associated with the device, and wherein the trajectory data may be stored on a cloud service.

Example 5 may include the system of example 1 and/or some other example herein, wherein the one or more inference models are generated using a machine learning algorithm to generate the one or more inference models, wherein the one or more inference models comprise at least one of a throughput inference model, a bit rate inference model, and a buffer length inference model.

Example 6 may include the system of example 5 and/or some other example herein, wherein the throughput inference model predicts a throughput of the wireless link at a subsequent time.

Example 7 may include the system of example 5 and/or some other example herein, wherein the bit rate inference model calculates a bit rate for downloading the media segment.

Example 8 may include the system of example 5 and/or some other example herein, wherein the buffer length inference model predicts an amount of data to be prefetched and stored on the device.

Example 9 may include a non-transitory computer-readable medium storing computer-executable instructions which when executed by one or more processors of a device result in performing operations comprising: determining a path trajectory; utilizing one or more inference models that predict one or more parameters associated with a media segment in a prefetch buffer on a wireless link; sending a request to a server, wherein the request indicates to the server to send the media segment using a predicted bit rate and a media segment prefetch size; and receiving a playback buffer from the server at the predicted bit rate.

Example 10 may include the non-transitory computer-readable medium of example 9 and/or some other example herein, wherein the one or more inference models are downloaded from a cloud service to the device.

Example 11 may include the non-transitory computer-readable medium of example 9 and/or some other example herein, wherein the one or more inference models are trained using data collected over time while traversing various environments.

Example 12 may include the non-transitory computer-readable medium of example 9 and/or some other example herein, wherein a training of the one or more inference models comprises continuous collection of trajectory data associated with the device, and wherein the trajectory data may be stored on a cloud service.

Example 13 may include the non-transitory computer-readable medium of example 9 and/or some other example herein, wherein the one or more inference models are generated using a machine learning algorithm to generate the one or more inference models, wherein the one or more inference models comprise at least one of a throughput inference model, a bit rate inference model, and a buffer length inference model.

Example 14 may include the non-transitory computer-readable medium of example 13 and/or some other example herein, wherein the throughput inference model predicts a throughput of the wireless link at a subsequent time.

Example 15 may include the non-transitory computer-readable medium of example 13 and/or some other example herein, wherein the bit rate inference model calculates a bit rate for downloading the media segment.

Example 16 may include the non-transitory computer-readable medium of example 13 and/or some other example herein, wherein the buffer length inference model predicts an amount of data to be prefetched and stored on the device.

Example 17 may include a method comprising: determining, by one or more processors of a device, a path trajectory; utilizing one or more inference models that predict one or more parameters associated with a media segment in a prefetch buffer on a wireless link; sending a request to a server, wherein the request indicates to the server to send the media segment using a predicted bit rate and a media segment prefetch size; and receiving a playback buffer from the server at the predicted bit rate.

Example 18 may include the method of example 17 and/or some other example herein, wherein the one or more inference models are downloaded from a cloud service to the device.

Example 19 may include the method of example 17 and/or some other example herein, wherein the one or more inference models are trained using data collected over time while traversing various environments.

Example 20 may include the method of example 17 and/or some other example herein, wherein a training of the one or more inference models comprises continuous collection of trajectory data associated with the device, and wherein the trajectory data may be stored on a cloud service.

Example 21 may include the method of example 17 and/or some other example herein, wherein the one or more inference models are generated using a machine learning algorithm to generate the one or more inference models, wherein the one or more inference models comprise at least one of a throughput inference model, a bit rate inference model, and a buffer length inference model.

Example 22 may include the method of example 21 and/or some other example herein, wherein the throughput inference model predicts a throughput of the wireless link at a subsequent time.

Example 23 may include the method of example 21 and/or some other example herein, wherein the bit rate inference model calculates a bit rate for downloading the media segment.

Example 24 may include the method of example 21 and/or some other example herein, wherein the buffer length inference model predicts an amount of data to be prefetched and stored on the device.

Example 25 may include an apparatus comprising means for: determining, by one or more processors of a device, a path trajectory; utilizing one or more inference models that predict one or more parameters associated with a media segment in a prefetch buffer on a wireless link; sending a request to a server, wherein the request indicates to the server to send the media segment using a predicted bit rate and a media segment prefetch size; and receiving a playback buffer from the server at the predicted bit rate.

Example 26 may include the apparatus of example 25 and/or some other example herein, wherein the one or more inference models are downloaded from a cloud service to the device.

Example 27 may include the apparatus of example 25 and/or some other example herein, wherein the one or more inference models are trained using data collected over time while traversing various environments.

Example 28 may include the apparatus of example 25 and/or some other example herein, wherein a training of the one or more inference models comprises continuous collection of trajectory data associated with the device, and wherein the trajectory data may be stored on a cloud service.

Example 29 may include the apparatus of example 25 and/or some other example herein, wherein the one or more inference models are generated using a machine learning algorithm to generate the one or more inference models, wherein the one or more inference models comprise at least one of a throughput inference model, a bit rate inference model, and a buffer length inference model.

Example 30 may include the apparatus of example 29 and/or some other example herein, wherein the throughput inference model predicts a throughput of the wireless link at a subsequent time.

Example 31 may include the apparatus of example 29 and/or some other example herein, wherein the bit rate inference model calculates a bit rate for downloading the media segment.

Example 32 may include the apparatus of example 29 and/or some other example herein, wherein the buffer length inference model predicts an amount of data to be prefetched and stored on the device.

Example 33 may include one or more non-transitory computer-readable media comprising instructions to cause an electronic device, upon execution of the instructions by one or more processors of the electronic device, to perform one or more elements of a method described in or related to any of examples 1-32, or any other method or process described herein.

Example 34 may include an apparatus comprising logic, modules, and/or circuitry to perform one or more elements of a method described in or related to any of examples 1-32, or any other method or process described herein.

Example 35 may include a method, technique, or process as described in or related to any of examples 1-32, or portions or parts thereof.

Example 36 may include an apparatus comprising: one or more processors and one or more computer readable media comprising instructions that, when executed by the one or more processors, cause the one or more processors to perform the method, techniques, or process as described in or related to any of examples 1-32, or portions thereof.

Example 37 may include a method of communicating in a wireless network as shown and described herein.

Example 38 may include a system for providing wireless communication as shown and described herein.

Example 39 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system, comprising: at least one memory that stores computer-executable instructions; and at least one processor configured to access the at least one memory and execute the computer-executable instructions to:
determine a path trajectory;
utilize one or more inference models that predict one or more parameters associated with a media segment in a prefetch buffer on a wireless link;
send a request to a server, wherein the request indicates to the server to send the media segment using a predicted bit rate and a media segment prefetch size; and
receive a playback buffer from the server at the predicted bit rate.

2. The system of claim 1, wherein the one or more inference models are downloaded from a cloud service to a mobile device.

3. The system of claim 1, wherein the one or more inference models are trained using data collected over time while traversing various environments.

4. The system of claim 1, wherein a training of the one or more inference models comprises continuous collection of trajectory data associated with a mobiledevice, and wherein the trajectory data is stored on a cloud service.

5. The system of claim 1, wherein the one or more inference models are generated using a machine learning algorithm to generate the one or more inference models, wherein the one or more inference models comprise at least one of a throughput inference model, a bit rate inference model, and a buffer length inference model.

6. The system of claim 5, wherein the throughput inference model predicts a throughput of the wireless link at a subsequent time.

7. The system of claim 5, wherein the bit rate inference model calculates a bit rate for downloading the media segment.

8. The system of claim 5, wherein the buffer length inference model predicts an amount of data to be prefetched and stored on a mobile device.

9. A non-transitory computer-readable medium storing computer-executable instructions which when executed by one or more processors of a device result in performing operations comprising:
determining a path trajectory;
utilizing one or more inference models that predict one or more parameters associated with a media segment in a prefetch buffer on a wireless link;
sending a request to a server, wherein the request indicates to the server to send the media segment using a predicted bit rate and a media segment prefetch size; and
receiving a playback buffer from the server at the predicted bit rate.

10. The non-transitory computer-readable medium of claim 9, wherein the one or more inference models are downloaded from a cloud service to the device.

11. The non-transitory computer-readable medium of claim 9, wherein the one or more inference models are trained using data collected over time while traversing various environments.

12. The non-transitory computer-readable medium of claim 9, wherein a training of the one or more inference models comprises continuous collection of trajectory data associated with the device, and wherein the trajectory data is stored on a cloud service.

13. The non-transitory computer-readable medium of claim 9, wherein the one or more inference models are generated using a machine learning algorithm to generate the one or more inference models, wherein the one or more inference models comprise at least one of a throughput inference model, a bit rate inference model, and a buffer length inference model.

14. The non-transitory computer-readable medium of claim 13, wherein the throughput inference model predicts a throughput of the wireless link at a subsequent time.

15. The non-transitory computer-readable medium of claim 13, wherein the bit rate inference model calculates a bit rate for downloading the media segment.

16. The non-transitory computer-readable medium of claim 13, wherein the buffer length inference model predicts an amount of data to be prefetched and stored on the device.

17. A method comprising:
determining, by one or more processors of a device, a path trajectory;
utilizing one or more inference models that predict one or more parameters associated with a media segment in a prefetch buffer on a wireless link;
sending a request to a server, wherein the request indicates to the server to send the media segment using a predicted bit rate and a media segment prefetch size; and
receiving a playback buffer from the server at the predicted bit rate.

18. The method of claim 17, wherein the one or more inference models are downloaded from a cloud service to the device.

19. The method of claim 17, wherein the one or more inference models are trained using data collected over time while traversing various environments.

20. The method of claim 17, wherein a training of the one or more inference models comprises continuous collection of trajectory data associated with the device, and wherein the trajectory data is stored on a cloud service.
